(19) United States
(12) Patent Application Publication
(10) Pub. No.: US 2009/0304894 A1
(43) Pub. Date: Dec. 10, 2009

(54) FISH-BASED FOODSTUFF

(76) Inventor: Arvind Kant Patel, Suva (FJ)

Correspondence Address: OCCHIUTI ROHLICEK & TSAO, LLP, 10 FAWCETT STREET, CAMBRIDGE, MA, 02138, US

(21) Appl. No.: 12/374,873

(22) PCT Filed: Jul. 24, 2007
(86) PCT No.: PCT/NZ07/00196

§ 371 Date: Jun. 15, 2009

(51) Int. Cl. A23L 1/325; A22C 25/20; A23L 1/01

(52) U.S. Cl. 426/574; 426/412; 426/643; 426/513; 426/509

(57) ABSTRACT

The invention relates to a fish-based product comprising at least fish meat, water, a starch premix and phosphate(s) and a method of making same. The product is preferably in loaf form, is substantially solid and not substantially prone to flaking or crumbling in use. The product also substantially retains the texture and flavour of unprocessed cooked fish meat.

### FIELD

The present invention relates to a novel foodstuff, particularly fish-based foodstuffs.

### BACKGROUND

Fish meat is soft and tends to crumble, flake and disintegrate, particularly once cooked. This problem is compounded when the fish meat is diced for example in 10-20 mm portions and can cause problems and inconvenience in use. For example, fish meat in a sandwich may crumble and fall out of the sandwich, causing wastage and making it messy to eat.

In addition, the crumbling and flaking properties of fish may make it difficult to produce a product in which the fish meat is sufficiently bound together to form a solid mass which is of desirable texture and taste and which can be cut and sliced without disintegrating. It is particularly difficult to produce products which include large chunks of natural fish meat. These problems may be compounded in the case of large scale production for the consumer market.

It would be desirable to produce a fish-based foodstuff which overcomes one or more of the above problems.

### OBJECT

It is an object of the present invention to provide a novel foodstuff or at least to provide the public with a useful choice.

### STATEMENT OF INVENTION

In one broad aspect of the present invention there is provided a fish-based product comprising at least fish meat, water, a starch premix and phosphate(s), wherein the product is substantially solid and not substantially prone to flaking or crumbling in use and which substantially retains the texture and flavour of substantially unprocessed cooked fish meat.

Preferably the product includes the following ingredients expressed in percentages by weight of total raw ingredients:

Approximately 70 to 80% fish meat
Approximately 9 to 12.5% water
Approximately 2 to 7% starch premix
Approximately 0.5% phosphate(s) (+/−0.5% of that value)

Preferably the product is a loaf.

Preferably the fish meat is Tuna. More preferably the fish meat is Yellow Fin or Albacore. Alternatively the fish meat is a mixture of Yellow Fin and Albacore.

Preferably the starch premix is a blend of potato, tapioca and cornflour starch. Preferably the starch premix comprises approximately 45 to 55% potato starch, approximately 35 to 45% tapioca starch and approximately 5 to 15% cornflour starch. More preferably the starch premix comprises approximately 50% potato starch, approximately 40% tapioca starch and approximately 10% cornflour starch.

Preferably the product also includes one or more of carrageenan, salt, curing salt, monosodium salt, and PolarTex™.

Preferably the product includes the following ingredients expressed in percentages by weight of total raw ingredients:

approximately 80% fish meat;
approximately 10.1% water;
approximately 6% starch premix:
approximately 1.5% carrageenan;
approximately 1.6% salt;
approximately 0.2% curing salt;
approximately 0.5% phosphates; and,
approximately 0.1% mono sodium salt.

Alternative the product includes the following ingredients expressed in percentages by weight of total raw ingredients:

approximately 80% fish meat;
approximately 10.2% water;
approximately 2.5% starch premix:
approximately 1.5% carrageenan;
approximately 1.6% salt;
approximately 0.2% curing salt;
approximately 0.5% phosphates; and,
approximately 3.5% PolarTex™.

In another broad aspect the invention provides a method for the manufacture of a fish-based product, wherein the product is substantially solid and not prone to flaking or crumbling in use and which substantially retains the texture and flavour of unprocessed cooked fish meat, the method comprising at least the steps:

Providing fish meat, water, starch premix and phosphates;
Dicing the fish meat;
Mixing the water, starch premix and phosphate(s) together to form a slurry;
Combining the diced fish meat and slurry to form a meat and slurry mix;
Resting the meat and slurry mix for a period;
Filling a food casing or mould with the meat and slurry mix;
Cooking the filled mould or casing to attain an internal temperature of approximately 75° C. to 80° C. for a period of at least approximately 15 to 20 minutes; and,
Cooling the product.

Preferably, fish meat is provided in an amount of approximately 70 to 80% by weight of total raw ingredients. Preferably, water is provided in an amount of approximately 9 to 12.5% by weight of total raw ingredients. Preferably, starch premix is provided in an amount of approximately 2 to 7% by weight of total raw ingredients. Preferably phosphates are provided in an amount of approximately 0.5% (+/−0.5% of that value) by weight of total raw ingredients.

Preferably the fish meat is Tuna. More preferably the fish meat is Yellow Fin or Albacore. Alternatively the fish meat is a mixture of Yellow Fin and Albacore.

Preferably the starch premix is a blend of potato, tapioca and cornflour starch. Preferably the starch premix comprises approximately 45 to 55% potato starch, approximately 35 to 45% tapioca starch and approximately 5 to 15% cornflour starch. More preferably the starch premix comprises approximately 50% potato starch, approximately 40% tapioca starch and approximately 10% cornflour starch.

Preferably, the method also includes combining additional ingredients with the starch premix, phosphate(s) and water to form the slurry. Preferably, the additional ingredients are one or more of: carrageenan, salt, curing salt, mono sodium salt and PolarTex™.

Preferably, the following ingredients are provided in the amounts expressed in percentages by weight of total raw ingredients:

approximately 80% fish meat;
approximately 10.1% water;
approximately 6% starch premix:
approximately 1.5% carrageenan;
approximately 1.6% Salt;
approximately 0.2% Curing salt;
approximately 0.5% Phosphates;
approximately 0.1% Mono sodium salt.

Alternatively, the following ingredients are provided in the amounts expressed in percentages by weight of total raw ingredients:

approximately 80% fish meat;
approximately 10.2% water;
approximately 2.5% starch premix:
approximately 1.5% carrageenan;
approximately 1.6% salt;
approximately 0.2% curing salt;
approximately 0.5% phosphates; and,
approximately 3.5% PolarTex™.

Preferably, the meat is diced into portions measuring approximately 20 mm by 20 mm.

Preferably the water is chilled water having a temperature of approximately 0° C. to 5° C.

Preferably, mixing of the diced fish meat and the slurry occurs via massaging. More preferably the massaging occurs using a vacuum tumbler. Preferably massaging occurs for a period of approximately 15 minutes to 2 hours, more preferably 30 minutes to 1 hour.

Preferably the starch premix, water and phosphates (and optionally other ingredients) are mixed at high speed for a period of approximately 3 to 4 minutes to form a slurry.

Preferably, the filled mould or casing is cooked to attain an internal temperature of approximately 78° C.

Preferably, cooking occurs in the presence of a water shower. Preferably, cooking occurs for a period of 90 minutes.

Preferably, the food casing is an edible food casing. More preferably, the edible food casing is a cellulose casing.

The invention may also be said broadly to consist in the parts, elements and features referred to or indicated in the specification of the application, individually or collectively, in any or all combinations of two or more of said parts, elements or features, and where specific integers are mentioned herein which have known equivalents in the art to which the invention relates, such known equivalents are deemed to be incorporated herein as if individually set forth.

### FIGURES

These and other aspects of the present invention, which should be considered in all its novel aspects, will become apparent from the following description, which is given by way of example only, with reference to the accompanying FIGURE, in which:

FIG. 1: Illustrates the process for producing an exemplary product according to the invention.

### PREFERRED EMBODIMENT(S)

The following is a description of the present invention, including preferred embodiments thereof, given in general terms. The invention will be further elucidated from the Examples provided hereafter.

Through novel processing steps and balancing of ingredients, particularly the design of a novel starch premix, the inventor has surprisingly produced a fish-based foodstuff in which the fish meat is bound together to form a substantially solid product which is not substantially prone to flaking, crumbling and disintegration when sliced or diced, but which substantially retains the texture and flavour of substantially unprocessed cooked fish. The inventor has been able to produce such a product, even in the presence of salt which, while being a desirable flavour enhancer, the inventor has identified to inhibit the binding of the fish meat.

The product provides a convenient alternative to canned fish meats such as tuna, while having the added benefits of not flaking or crumbling when cut or when in use. Accordingly, it may alleviate problems associated with spilling of fish meat out of sandwiches and crumbling of meat during cooking and the like. It also has the advantage of having a texture and flavour which is substantially the same as unprocessed cooked fish meat, which is significant for such a processed product.

The product of the invention preferably takes the form of a loaf, roll, luncheon sausage or equivalent product. As such, the product may be referred to herein after as a “fish loaf”. However, this should not be interpreted as limiting the scope of the invention.

The foodstuff of the invention has use as a ready-to-eat product which may be sliced and eaten as a snack, or used in sandwiches and salads, for example. It also has use in delicatessen or supermarket settings, in which the loaf is displayed and sold pre-sliced. In addition, the product has use in the preparation of frozen foods such as frozen pizza's and ready-made meals. Other applications may be readily appreciated by persons of skill in the art to which the invention relates.

The foodstuff comprises at least fish meat, water, a starch premix and phosphate(s).

The starch premix comprises potato starch, tapioca starch, and cornflour starch. Preferably the starch premix comprises approximately 45 to 55% potato starch, approximately 35 to 45% tapioca starch and approximately 5 to 15% cornflour starch. More preferably the starch premix comprises approximately 50% potato starch, approximately 40% tapioca starch and approximately 10% cornflour starch.

The inventor has found the phosphate blend TARI P22 (available from Fibrisol Services Australia Pty Limited) to be a preferable source of phosphate(s) for the invention. However, persons of ordinary skill in the art to which the invention relates may readily appreciate alternative phosphate(s), including phosphate blends, of use in the invention.

The fish meat may be derived from a single species of fish. Alternatively the fish meat is derived from a mixture of different species of fish. In a preferred embodiment of the invention the fish is tuna, more preferably Yellow Fin and/or Albacore. The fish could also be Wahu. Most preferably, Yellow Fin is the sole source of fish meat. Alternatively, Albacore is the sole source of fish meat, or a combination of Yellow Fin and Albacore is used.

The amount of fish meat in the product may vary depending on factors such as the weight and solid meat quality of the fish. The inventors have found that fish weighing between 10-15 kg are preferable to providing a desirable texture to the product. Accordingly, fish meat is preferably present in an amount of approximately 70 to 80% by weight of total raw ingredients. Most preferably the fish meat is in an amount of approximately 80% by weight of total raw ingredients.

The amount of water in the product may vary depending on factors such as the weight of the fish; generally speaking the smaller the fish the higher the water content thereof. One can regulate the amount of water used in the product on the basis of the moisture content of the raw fish meat. The inventors have found that fish weighing between 10-15 kg are most preferable. Accordingly, approximately 9 to 12.5% water by weight of total raw ingredients is used in the product. In preferred embodiments of the invention described herein, approximately 10.1% or 10.2% water is used.

It should be appreciated that when referring to the amount of water in the product of the invention reference is being made to the amount of water added as an ingredient (as is the case when referring to other ingredients). However, the total water or moisture content of the final product may differ from the amount of water used as an ingredient; by way of example the fish meat may contain a level of water which could increase water or moisture content above the amount recited herein. One can regulate the amount of

Preferably, the starch premix is used in an amount of approximately 2 to 7% by weight of total raw ingredients. In embodiments of the invention where the starch premix is the only starch ingredient present in the product it is preferably used in an amount of approximately 5 to 7% and most preferably in an amount of approximately 6% by weight of total raw ingredients. Where other starches (including modified starches) or starch-based products are present in the product (as will be discussed and exemplified herein after), the level of starch premix may be reduced, for example to between approximately 2 to 5% and most preferably to approximately 2.5%. However, the total starch used in the product should preferably remain in the range between approximately 5% to 7% by weight of total raw ingredients.

Preferably phosphate(s) are used in an amount of approximately 0.5% (+/−0.5% of that value).

The product may contain ingredients in addition to those listed above. For example preservatives, binders and ingredients that enhance flavours or mouth feel, or provide health benefits, and ingredients that help maintain moisture content or at least minimise moisture loss from the product may be used.

In a particularly preferred embodiment of the invention the product includes one or more of carrageenan, salt, curing salt, and monosodium salt. Preferably the product includes all of these ingredients. Preferably carrageenan is used in an amount of approximately 1.5% (the inventor has found this to be useful in obtaining a product of the desired texture which does not flake and crumble), salt (sodium chloride) in an amount of approximately 1.6%, curing salt in an amount of approximately 0.2% and monosodium salt in an amount of approximately 0.1%. Percentages provided are percentages by weight of total raw ingredients. The inventors contemplate these ingredients being used in quantities ranging from +/−0.5% of the % by weight specifically referred to.

In another particularly preferred embodiment of the invention the product includes PolarTex™ or other suitable product. The inventor has found PolarTex™ (a modified starch) to be particularly useful for the purpose of helping to maintain moisture content or reduce moisture loss during use and storage of the product. However, it should be appreciated that one or more equivalent products could be used. Preferably PolarTex™ is used in an amount of approximately 40 g/kg of fish meat. In a preferred form of the invention, PolarTex™ is used in an amount of approximately 3 to 4% of total raw ingredients, most preferably approximately 3.5%.

In a particularly preferred embodiment of the invention the product includes each of carrageenan, salt, curing salt and PolarTex™. Preferably, carrageenan is used in an amount of approximately 1.5%, salt (sodium chloride) in an amount of approximately 1.6%, curing salt in an amount of approximately 0.2%, and PolarTex™ in an amount of approximately 3.5%. Percentages provided are percentages by weight of total raw ingredients.

The inventor contemplates herbs and spices including Italian herbs and Asian spices, and omega-3 oil being included in the product. Acidic ingredients should be avoided or at least kept to a minimum.

To make the product of the invention, at least fish meat, water, starch premix and phosphates are provided. Other ingredients may also be provided as herein described. The fish meat is preferably provided in an amount of approximately 70 to 80% by weight of total raw ingredients, the water in an amount of approximately 9 to 12.5% by weight of total raw ingredients, the starch premix in an amount of approximately 2 to 7% by weight of total raw ingredients and the phosphates in an amount of approximately 0.5% (+/−0.5% of that value) by weight of total raw ingredients.

The fish meat, which has preferably been boned, skinned and filleted, is preferably chilled to a temperature of approximately −5° C. to 5° C. In a preferred embodiment of the invention, fish used in the product are chilled as soon as possible after being caught, and are maintained in a chilled state during processing, to at least minimise or prevent growth of micro-organisms. Chilling may also help maintain the desired texture of the meat.

The fish meat is then cut or diced. Preferably, the meat is gently diced so as to avoid bruising or damaging the meat. Preferably the meat is diced into portions measuring approximately 20 mm by 20 mm. Preferably, a dicing apparatus or machine having an approximately 20 mm hole plate is used to dice the meat.

The water, starch premix and preferably phosphate(s) are mixed together. Most preferably the water is at a temperature of approximately 0 to 5° C. Any suitable method may be used to mix or blend the water, starch premix and phosphates to form a slurry of substantially uniform consistency. Most preferably the water, starch premix and phosphates are mixed for a period of approximately 3 to 4 minutes in a high speed mixer with a pump (for example a circulating Silverson pump) to form a slurry; for example 1500 rpm (or a volume of 60 litres/min).

It should be appreciated that other ingredients may be combined with the water, starch premix and phosphates to form the slurry. In a preferred embodiment of the invention carrageenan, salt, curing salt, monosodium salt, and phosphate(s) are combined with the starch premix and water and processed to form a slurry as described herein. In a most preferred embodiment of the invention PolarTex™, carrageenan, salt, curing salt and phosphates are combined with the water, starch premix and phosphates and processed to form a slurry as described.

The diced fish meat and the slurry are then combined. Preferably the diced fish meat and the slurry are combined by massaging or equivalent technique so as to substantially retain the natural texture of the fish meat and to help prevent damage to, or bruising of, the meat. In a most preferred embodiment the mixture is massaged through a vacuum tumbler or alternative apparatus or machine which achieves the desired result. By way of example, to process, the tumbler is sealed, a vacuum of 3″ Hg applied and the mixture tumbled for approximately 15 minutes to 1.5 to 2 hours. More preferably the mixture is tumbled for approximately 30 minutes to 1 hour.

Following the combining of the meat and slurry, the mixture is preferably chilled and rested for a period, preferably at least 12 hours, although shorter periods, for example 6 hours, could be used. Most preferably the mixture is rested at a temperature of approximately 4° C.

After resting, the mixture can be moulded to form a desired shape. Preferably the mixture is placed in a suitable food casing or mould of desired shape and size. In a most preferable embodiment, an edible food casing is used. Preferably the edible food casing is a cellulose casing. Alternatively, appropriate plastic casings such as nylon casings or other known food casings such as cans are used. Most preferably, the casing is an approximately 150 mm cellulose casing.

Any appropriate method may be used to fill the desired casing or mould. Preferably the method is adapted to minimise or prevent the presence air bubbles within the product (for example between the filling and the casing, and within the filling). Preferably the method is adapted to minimise or prevent damage and bruising of the fish meat during the filling process. A preferred methodology is provided herein after under in the Examples section, under the heading “Part D: Filling Casings”. This preferred methodology uses a vacuum filling apparatus.

Once filled the casings are preferably stored at approximately 5° C. until required for cooking. Most preferably, the filled casings are stored for less than 30 minutes prior to cooking.

The filled casings are then cooked so as to attain an internal temperature of approximately 75° C. to 80° C., most preferably a temperature of approximately 78° C., for a period of at least approximately 15 to 20 minutes. Most preferably, the product is cooked in a cooker with a water shower program set at approximately 78° C., for approximately 90 minutes. Cooking in a water shower helps to ensure uniform cooking and an extended shelf life.

Processing of the product can occur in an environment which allows for the product to have a “smoked” flavour. Persons of ordinary skill in the art to which the invention relates will appreciate how this may be achieved. However, by way of example the product may be cooked in a smoking chamber, a smoked flavoured casing could be used, or appropriate ingredients could be used to provide a smoked flavour (for example liquid or powdered flavourings).

Following cooking, the product can be left to cool. Preferably, at least a first step in the cooling process is cooling the product in an apparatus, for example a cooker, set to approximately 50° C. for approximately 30 minutes.

The product can also be cooled by covering with crushed ice or circulated refrigerated chilled water for approximately 60 minutes. Preferably, this cooling step occurs in addition to the cooling step of the previous paragraph. The product can be stored in a chilled environment for up to approximately 6 months.

### EXAMPLES

### Raw Materials/Ingredients

Boneless, skinned and chilled tuna loins from Yellow Fin and/or Albacore. Most preferably the fish is at a temperature of approximately −5° C. to 5° C.
Iced Water at approximately 0° C. to 5° C.
Starch Premix (consisting of potato, tapioca and cornflour starch in proportions of approximately 50%, 40% and 10% respectively).
Salt (sodium chloride).
Curing Salt (sodium nitrate)—E250, BASF AG, Germany.
Phosphates—Phosphate blend TARI P22, Fibrisol Services Australia Pty Limited (53-59 Sunmore Close, Heatherton, Vic 3202, Australia).
Monosodium salt.

### Carrageenan—Oppenheimer Pty Ltd (5/107 Carnarwan Street, Silverwater, NSW 2128, Australia)

PolarTex™—(modified starch)—Cargill Incorporated, 15407 McGinty Road West Wayzata Minn. 55391, United States of America (supplied by Quality Ingredient, D3, 3-9 Birnie Avenue, Lidcombe, NSW 1825, Australia)
Cellulose Casing 150 mm diameter (food grade), Devro Pty Limited, PO Box 2523, Stortford Lodge, Hastings, New Zealand.

### Example 1

The ingredients are added in the following percentages by weight of total raw ingredients:

Fish meat 80%, water 10.1%, starch premix 6%, salt 1.6%, curing salt 0.2%, phosphates 0.5%, monosodium salt 0.1% and carrageenan 1.5%.

### Process

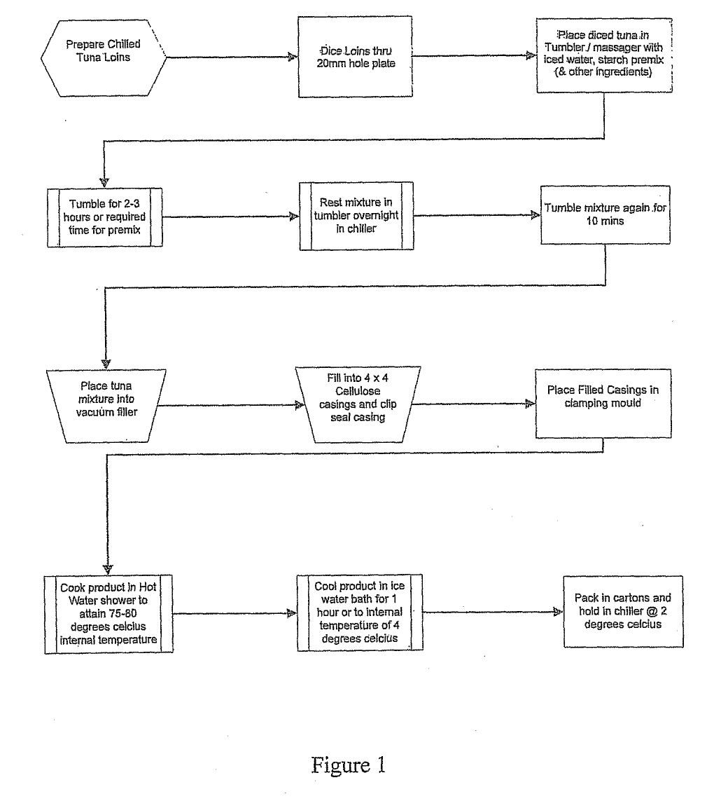

The process as illustrated in FIG. 1 and described below is followed to prepare the foodstuff of a preferred embodiment of the invention:

### Part A: Preparation

1. Chilled tuna loins inspected for any skin, sinew & general cleanliness
2. Check loin temperatures are <5° C. before dicing

### Part B: Dicing

1. Dice through HT Barnes dicer with a 20 mm hole plate
2. Transfer diced loins to tumbler or massager

### Part C: Tumbling/Massaging

1. Transfer diced tuna loins to tumbler
2. Add ice & water to starch premix, carrageenan, salt, curing salt, monosodium salt, and phosphates in separate tank & blend to form a slurry
3. Pour blended premix into tumbler with tuna
4. Seal tumbler & draw vacuum to 3″ Hg
5. Tumble for 1 hour
6. Place tumbler in chiller & rest overnight—at least 12 hours
7. Tumble for further 10 mins & empty tuna mixture into vacuum filler
8. Check that mixture temperature is less than 5° C.

### Part D: Filling Casings

Using 150 mm Cellulose Casing and Clipsal Seal Clips

1. Ensure casings are clipped at one end
2. Use 40 mm head on vacuum filler
3. Feed casing over filling head so that the clipped end is touching the fill head
4. Fill casing to 2.5 kgs ensuring no air bubbles or pockets are formed
5. Clip seal filled casing & place in cook tray
6. Place trays in 5° C. chiller till required for cooking—<30 mins

### Part E: Cooking Process

1. Place filled casings in stainless steel 4×4 mould & clamp
2. Place all moulds on perforated retort trays & stack trays on retort trolley
3. Load trolley(s) into retort
4. Insert temperature logger probe into a central sited roll & seal door shut ensuring probe cable is not twisted
5. Set cooking program for water shower to 78° C. for 90 minutes to attain an internal temperature of 78° C.
6. Set cooling temperature to 50° C. for 30 minutes
7. Set over pressure at zero—no cooking pressure required
8. Start cook program

### Part F: Cooling and Storage

1. Remove tuna hams from retort & place in cooling tank
2. Cover hams with crushed ice and cool for 60 minutes
3. Check internal temperature of hams are <5° C. before placing in storage chiller at 4° C.
4. Pack & label to suit appropriate market
5. Always keep chilled to attain the 6 month shelf life

### Example 2

The product is made in accordance with Example 1 but for the following modifications:
1. An additional ingredient, PolarTex™, is included in the product. PolarTex™ is used at 40 g/kg of fish meat. Accordingly, the ingredients are provided in the following percentages by weight of total raw ingredients: Fish meat 80%, water 10.2%, starch premix 2.5%, salt 1.6%, curing salt 0.2%, phosphates 0.5%, carrageenan 1.5% and PolarTex™ 3.5%.
2. At Part C, 2 of the process (using the paragraph numbering of Example 1) ice & water are added to the starch premix, carrageenan, salt, curing salt, phosphates, and the PolarTex™ in separate tank & blended to form a slurry.

The invention has been described herein, with reference to certain preferred embodiments, in order to enable the reader to practice the invention without undue experimentation. However, a person having ordinary skill in the art will readily recognise that many of the components and parameters may be varied or modified to a certain extent or substituted for known equivalents without departing from the scope of the invention. It should be appreciated that such modifications and equivalents are herein incorporated as if individually set forth. Titles, headings, or the like are provided to enhance the reader's comprehension of this document, and should not be read as limiting the scope of the present invention.

The reference to any prior art in this specification is not, and should not be taken as, an acknowledgment or any form of suggestion that that prior art forms part of the common general knowledge in New Zealand or in any other country in the world.

Throughout this specification, unless the context requires otherwise, the words “comprise”, “comprising” and the like, are to be construed in an inclusive sense as opposed to an exclusive sense, that is to say, in the sense of “including, but not limited to”.

1. A fish-based product comprising at least fish meat, water, a starch premix and phosphate(s), wherein the product is substantially solid and not prone to flaking or crumbling in use and which substantially retains the texture and flavor of substantially unprocessed cooked fish meat.

2. A product as claimed in claim 1 wherein the product contains the following ingredients expressed in percentages by weight of total raw ingredients:
Approximately 70 to 80% fish meat
Approximately 9 to 12.5% water
Approximately 2 to 7% starch premix
Approximately 0.5% phosphate(s) (+/−0.5% of that value)

3. A product as claimed in claim 1 wherein it is a loaf.

4. A product as claimed in claim 1 wherein the fish meat is Tuna.

5. A product as claimed in claim 4 wherein the fish meat is Yellow Fin or Albacore.

6. A product as claimed in claim 5 wherein the fish meat is a mixture of Yellow Fin and Albacore.

7. A product as claimed in claim 1 wherein the starch premix is a blend of potato, tapioca and cornflour starch.

8. A product as claimed in claim 7 wherein the starch premix comprises approximately 45 to 55% potato starch, approximately 35 to 45% tapioca starch and approximately 5 to 15% cornflour starch.

9. A product as claimed in claim 8 wherein the starch premix comprises approximately 50% potato starch, approximately 40% tapioca starch and approximately 10% cornflour starch.

10. A product as claimed in claim 1 wherein the product also includes one or more of carrageenan, salt, curing salt, monosodium salt and PolarTex™.

11. A product as claimed in claim 10 wherein the product includes the following ingredients expressed in percentages by weight of total raw ingredients:
approximately 80% fish meat;
approximately 10.1% water;
approximately 6% starch premix:
approximately 1.5% carrageenan;
approximately 1.6% salt;
approximately 0.2% curing salt;
approximately 0.5% phosphates; and,
approximately 0.1% mono sodium salt.

12. A product as claimed in claim 10 wherein the product includes the following ingredients expressed in percentages by weight of total raw ingredients:
approximately 80% fish meat;
approximately 10.2% water;
approximately 2.5% starch premix:
approximately 1.5% carrageenan;
approximately 1.6% salt;
approximately 0.2% curing salt;
approximately 0.5% phosphates; and
approximately 3.5% PolarTex.

13. A method for the manufacture of a fish-based product, wherein the product is substantially solid and not prone to flaking or crumbling in use and which substantially retains the texture and flavor of unprocessed cooked fish meat, the method comprising at least the steps:
a) Providing fish meat, water, starch premix and phosphates;
b) Dicing the fish meat;
c) Mixing the water, starch premix and phosphate(s) together to form a slurry;
d) Combining the diced fish meat and slurry to form a meat and slurry mix;
e) Resting the meat and slurry mix for a period;
f) Filling a food casing or mould with the meat and slurry mix;
g) Cooking the filled mould or casing to attain an internal temperature of approximately 75° C. to 80° C. for a period of at least approximately 15 to 20 minutes; and,
h) Cooling the product.

14. A method as claimed in claim 13 wherein the fish meat is provided in an amount of approximately 70 to 80% by weight of total raw ingredients.

15. A method as claimed in claim 13 wherein water is provided in an amount of approximately 9 to 12.5% by weight of total raw ingredients.

16. A method as claimed in claim 13 wherein starch premix is provided in an amount of approximately 2 to 7% by weight of total raw ingredients.

17. A method as claimed in claim 13 wherein phosphates are provided in an amount of approximately 0.5% (+/−0.5% of that value) by weight of total raw ingredients.

18. A method as claimed in claim 13 wherein the fish meat is Tuna.

19. A method as claimed in claim 18 wherein the fish meat is Yellow Fin or Albacore.

20. A method as claimed in claim 19 wherein the fish meat is a mixture of Yellow Fin and Albacore.

21. A method as claimed in claim 13 wherein the starch premix is a blend of potato, tapioca and cornflour starch.

22. A method as claimed in claim 21 wherein the starch premix comprises approximately 45 to 55% potato starch, approximately 35 to 45% tapioca starch and approximately 5 to 15% cornflour starch.

23. A method as claimed in claim 22 wherein the starch premix comprises approximately 50% potato starch, approximately 40% tapioca starch and approximately 10% cornflour starch.

24. A method as claimed in claim 13 wherein the method also includes combining one or more of the following ingredients with the starch premix, phosphate(s) and water to form the slurry: carrageenan, salt, curing salt, mono sodium salt, and PolarTex™.

25. A method as claimed in claim 24 wherein the ingredients are provided in the following amounts expressed in percentages by weight of total raw ingredients:
approximately 80% fish meat;
approximately 10.1% water;
approximately 6% starch premix:
approximately 1.5% carrageenan;
approximately 1.6% Salt;
approximately 0.2% Curing salt;
approximately 0.5% Phosphates; and,
approximately 0.1% Mono sodium salt.

26. A method as claimed in claim 24 wherein the ingredients are provided in the following amounts expressed in percentages by weight of total raw ingredients:
approximately 80% fish meat;
approximately 10.2% water;
approximately 2.5% starch premix:
approximately 1.5% carrageenan;
approximately 1.6% Salt;
approximately 0.2% Curing salt;
approximately 0.5% Phosphates; and,
approximately 3.5% PolarTex™.

27. A method as claimed in claim 13 wherein the meat is diced into portions measuring approximately 20 mm by 20 mm.

28. A method as claimed in claim 13 wherein the water is chilled water having a temperature of approximately 0° C. to 5° C.

29. A method as claimed in claim 13 wherein mixing of the diced fish meat and the slurry occurs via massaging.

30. A method as claimed in claim 29 wherein the massaging occurs using a vacuum tumbler.

31. A method as claimed in claim 30 wherein the massaging occurs for a period of approximately 15 minutes to 2 hours, preferably 30 minutes to 1 hour.

32. A method as claimed in claim 13 wherein the starch premix, water and phosphates (and optionally other ingredients) are mixed at high speed for a period of approximately 3 to 4 minutes to form a slurry.

33. A method as claimed in claim 13 wherein the filled mould or casing is cooked to attain an internal temperature of approximately 78° C.

34. A method as claimed in claim 13 wherein the cooking occurs in the presence of a water shower.

35. A method as claimed in claim 13 wherein the cooking occurs for a period of 90 minutes.

36. A method as claimed in claim 13 wherein the food casing is an edible food casing.

37. A method as claimed in claim 36 wherein the edible food casing is a cellulose casing.
